(19) United States
(12) Patent Application Publication
(10) Pub. No.: US 2007/0248495 A1
(43) Pub. Date: Oct. 25, 2007

(54) Sensory Evaluation Device

(76) Inventors: Charles F. Fritter, Dublin, CA (US); Heather L. Day, San Lorenzo, CA (US); Rajesh K. Gupta, Bay Point, CA (US); Naymesh G. Patel, San Ramon, CA (US)

Correspondence Address: THE CLOROX COMPANY, P.O. BOX 24305, OAKLAND, CA, 94623-1305, US

(21) Appl. No.: 11/379,924

(22) Filed: Apr. 24, 2006

(51) Int. Cl. B32B 27/04

(52) U.S. Cl. 422/88

(57) ABSTRACT

A sensory evaluation device, and methods of using the same, for the evaluation of the efficacy of odor-absorbing compositions, particularly animal litters. The sensory evaluation device includes a first chamber containing one odor-absorbing composition suitable for use as an animal litter coupled to a second chamber containing a second odor-absorbing composition suitable for use as an animal litter. Each odor-absorbing composition is dosed with an odor-emitting substance, preferably colored such that the dosing is visible. Each chamber contains a vapor-permeable barrier, which is capable of communication with the ambient environment. The vapor-permeable barriers are protected from the ambient environment by vapor-permeable barrier protectors, which are removably coupled to the vapor-permeable barriers. More than one sensory evaluation device may be comparatively used by a single user at one time.

### BACKGROUND OF THE INVENTION

1. Field of the Invention

The present invention relates generally to disposable scent sampling devices, and, more specifically, to a disposable scent sampling device for the evaluation of animal litter.

2. Description of the Related Art

Fragrance sampling devices exist which are easily distributed to a large number of people, are user-friendly and can be utilized at the discretion of the consumer. However, those currently available are primarily directed to dispensing small quantities of substances such as perfumes or colognes.

One of the most common and distressing household odors is caused by pets, such as cats, who must void or eliminate in the home in discrete areas, such as litter boxes or other containment devices. The typical litter box must contain in the neighborhood of 5 to 20 pounds of litter to effectively absorb and/or control pet odors and waste products. Typical litter products are sold in packages ranging in size from about 5 to 50 pounds and costing approximately $5.00 to $50.00. Thus, it is desirable to have a device that is easily distributed to a large number of people, is user-friendly and allows the consumer to evaluate the odor-controlling effectiveness of a litter product at his/her convenience.

### SUMMARY OF THE INVENTION

An object of the invention includes a sensory evaluation device that comprises at least one chamber closed off from the ambient environment. The chamber contains at least one odor-absorbing composition suitable for use as an animal litter. The odor-absorbing composition has at least one odor-emitting substance in direct communication with it. A vapor-permeable barrier separates the chamber from the ambient environment and the vapor-permeable barrier is protected from the ambient environment until contact is desired by a vapor-permeable barrier protector. The vapor-permeable barrier protector is removably coupled to the chamber.

Another object of the invention includes a method of using a sensory evaluation device to evaluate the effectiveness of animal litter comprising: (1) storing a sensory evaluation device that has a chamber closed off from the ambient environment containing an odor-absorbing composition suitable for use as an animal litter; an odor-emitting substance in direct communication with the odor-absorbing composition; and a chamber protector removably coupled to the chamber protecting the chamber from the ambient environment until removed; (2) removing the chamber protector from the chamber to bring the contents of the chamber in communication with the ambient environment; and (3) allowing a person to sniff the contents of the chamber.

### BRIEF DESCRIPTION OF THE DRAWINGS

Reference will now be made to the drawings wherein like numerals refer to like parts throughout, and wherein:

FIG. 1 is a top plan view of a sensory evaluation device that includes a first sample chamber connected to a second sample chamber;

FIG. 2 is a cross-sectional view of the sampling device of FIG. 1 taken along the line 2′-2′;

FIG. 3 is a top plan view of another embodiment of a sensory evaluation device that includes a first chamber coupled to a second chamber; and

FIG. 4 is a top plan view of another embodiment of a sensory evaluation device that includes a first chamber coupled to a second chamber wherein the second chamber is contained inside the first chamber.

### DETAILED DESCRIPTION

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner.

It must be noted that, as used in this specification and the appended claims, the singular forms “a,” “an” and “the” include plural referents unless the content clearly dictates otherwise. Thus, for example, reference to an “odor absorbing composition” includes two or more such compositions.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

The embodiments disclosed herein are described in the context of a sensory evaluation device that a consumer can use unassisted, e.g., in the store or in the home, to evaluate the odor-controlling effectiveness of an odor-absorbing composition, e.g., an animal litter. One of ordinary skill in the art would recognize, however, that the materials and methods disclosed herein will have application in a number of other contexts where sensory evaluation of a particular composition is desirable, particularly where simplicity and ease of use is important.

Odor-absorbing compositions may comprise any solid material that has odor-absorbing properties and is compatible with the material used to construct the sensory evaluation device. Of particular interest for use in the present invention are clay or other mineral-based litter compositions, silica gel-based litter compositions, liquid adsorbing organic material-based litter compositions, and re-usable non-absorbent substrates designed to control odors. As used herein, the term clay-based litter material refers to an animal litter having clay as the primary liquid absorbing constituent, the term silica gel-based litter refers to an animal litter having silica gel as the primary liquid absorbing constituent, and so on.

Odor-emitting substances may comprise any materials that are compatible with the material used to construct the sensory evaluation device and that emit a human-detectable odor. Preferably, the odor-emitting substance is non-toxic to humans and animals and has a potent enough odor that it can be detected in small doses (e.g., about 1-10 drops from an eye-dropper, if a liquid or solubilized in a liquid). Exemplary odor-emitting substances include garlic oil, ammonia, onion powder, coffee, fish oil, sesame oil, vinegar as well as actual waste products from animals such as cats. The odor-emitting substances can be dyed a color such that the user of the sensory evaluation device has a visual indication that the odor absorbing material has been dosed.

A basic design of one embodiment of the device comprises at least one chamber in communication with the ambient environment via a vapor-permeable barrier or membrane (hereinafter collectively referred to as a “barrier”). The vapor-permeable barrier may be constructed of plastic, metal foil, paper, glass, non-woven material, materials designed to transmit specific chemicals or combinations thereof. To reduce the risk of inhalation of fine solid particulates, it is desirable that the vapor-permeable barrier be permeable to vapors, but not permeable to solids greater than 500 μm. The barrier may be made of a perforated or non-perforated material possessing the above-mentioned permeability parameters either with or without perforation. To insure that no solids pass through the barrier, it is preferable that the material be non-perforated.

The chamber has a trough to hold the odor-absorbing material. A vapor-permeable barrier protector removably attached to the vapor-permeable barrier provides a seal between the ambient environment and the contents of the chamber until the user is ready to conduct the sensory evaluation. The odor-absorbing material may be pre-dosed with an odor-emitting substance. For example, the trough may comprise a jar and the vapor-permeable barrier protector may comprise a lid. A perforated piece of paper-supported metal foil may comprise the vapor-permeable barrier.

An alternate embodiment includes a device with two or more similarly constructed chambers either attached or unattached to one another to allow the consumer to compare two or more odor-absorbing materials or to compare the odor-absorbing effectiveness of one odor-absorbing material with regard to two or more odor-emitting substances.

Other embodiments include sensory evaluation devices that allow the consumer to dose the odor absorbing material with the odor-emitting substance. In one embodiment, the device comprises a first chamber containing the odor-absorbing material and a second chamber containing the odor-emitting substance, wherein the first chamber is sealed and is contained within the second chamber. The second chamber is in communication with the ambient environment via a vapor-permeable barrier. To reduce the risk of inhalation of fine solid particulates, it is desirable that the vapor-permeable barrier be permeable to vapors, but not permeable to solids greater than about 500 μm. The barrier may be made of a perforated or non-perforated material possessing the above-mentioned permeability parameters either with or without perforation. The vapor-permeable barrier may be constructed of plastic, metal foil, paper, glass, non-woven material, materials designed to transmit specific chemicals or mixtures thereof. To insure that no solids pass through the barrier, it is preferable that the material be non-perforated. A vapor-permeable barrier protector is removably attached to the vapor-permeable barrier. The barrier protector provides a seal between the ambient environment and the contents of the second chamber until the user is ready to make the sensory evaluation.

Once ready to conduct the evaluation, the user removes the barrier protector and smells the contents of the second chamber. The user then replaces the barrier protector and breaks the seal on the first chamber to empty the contents of the first chamber into the second chamber facilitating the dosing of the odor-emitting substance with the odor-absorbing material. Once dosed, the user removes the barrier protector and again smells the contents of the second chamber.

An alternate embodiment includes a device with two or more similarly constructed chambers within a chamber designed to allow the consumer to compare two or more odor-absorbing materials, or to compare the odor-absorbing effectiveness of one odor-absorbing material with regard to two or more odor-emitting substances.

The exterior of the sensory evaluation devices described above can be constructed of any suitable packaging material. At least a portion of the chamber(s) should be at least partially light transmissive, i.e., transparent or translucent, such that the user is able to easily see that the odor-absorbing material has been dosed with the odor-emitting substance, whereas the vapor-permeable barrier and barrier protector can be either opaque or partially light transmissive. Non-limiting examples of effective packaging materials include a homopolymer olefin material, a random copolymer olefin material, PS (polystyrene), CPET (crystalline polyethylene terephthalate), APET (amorphous polyethylene terephthalate), HDPE (high density polyethylene), PVC (polyvinyl chloride), and PC (polycarbonate).

In operation, the sensory evaluation devices may be presented to the consumer in a variety of ways. For example, a device may be demonstrated in-store live to the consumer; it may be demonstrated live to the consumer at a location other than a store; it may be made available to the consumer in-store for self use; or it may be distributed directly to the consumer for self-use by mail or any other means designed to reach a residence. The sensory evaluation devices can be stored for extended periods of time prior to use. Once ready to use, the user removes the protectors and sniffs the contents.

The following are exemplary embodiments of the present invention.

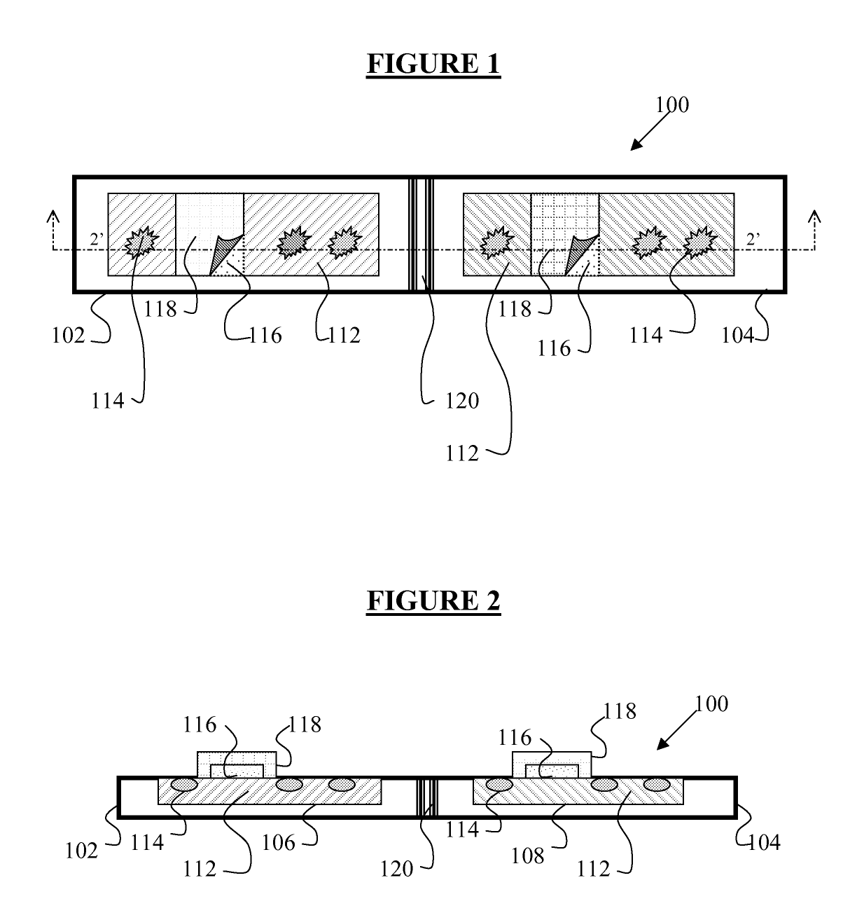

FIG. 1 is a top plan view of a sensory evaluation device 100 that includes a first chamber 102 connected to a second chamber 104 via an impermeable barrier 120.

FIG. 2 is a cross-sectional view of sampling device 100 of FIG. 1 taken along the line 2′-2′.

As used herein, positional terms, such as “top” and “bottom” and the like, and directional terms, such as “up” and “down” and the like, are employed for ease of description in conjunction with the drawings. These terms are not meant to indicate that the components of the present invention must have a specific orientation except when specifically set forth below.

Referring to FIGS. 1 and 2 together, in this embodiment, first chamber 102 and second chamber 104 are similar plate-like members that define cavities, in which a first trough 106 and a second trough 108 are, respectively, disposed. The chambers are separated by an impermeable barrier 120. In one embodiment, first trough 106 and second trough 108 each contain an odor-absorbing composition 112 dosed with an odor-emitting substance 114. To provide the consumer with an immediate comparison of the odor-absorbing effectiveness of two different odor-absorbing compositions, the troughs may contain different odor absorbing compositions dosed with an equal amount of the same odor-emitting substance. The embodiment shown contains two sample chambers, although any number of additional chambers could be added if it is desirable to make more than one comparison. Each chamber has a vapor-permeable barrier 116 that facilitates the communication of the chamber to the ambient environment. Removably attached to each vapor-permeable barrier 116 is a barrier protector 118 that provides a seal between the ambient environment and the contents of the chamber. The seal may be reversible or irreversible, i.e., easily resealable versus a one time use.

In one embodiment, the vapor-permeable barrier 116 and barrier protector 118 are in an overlying configuration. The bottom peripheral edges of barrier protector 118 may contain an adhesive material (not shown) to removably couple and provide a seal between chambers 102 and 104 and the ambient environment. Other means to couple barrier protector 118 and vapor-permeable barrier 116 are possible, such as by way of example and not by way of limitation, static cling.

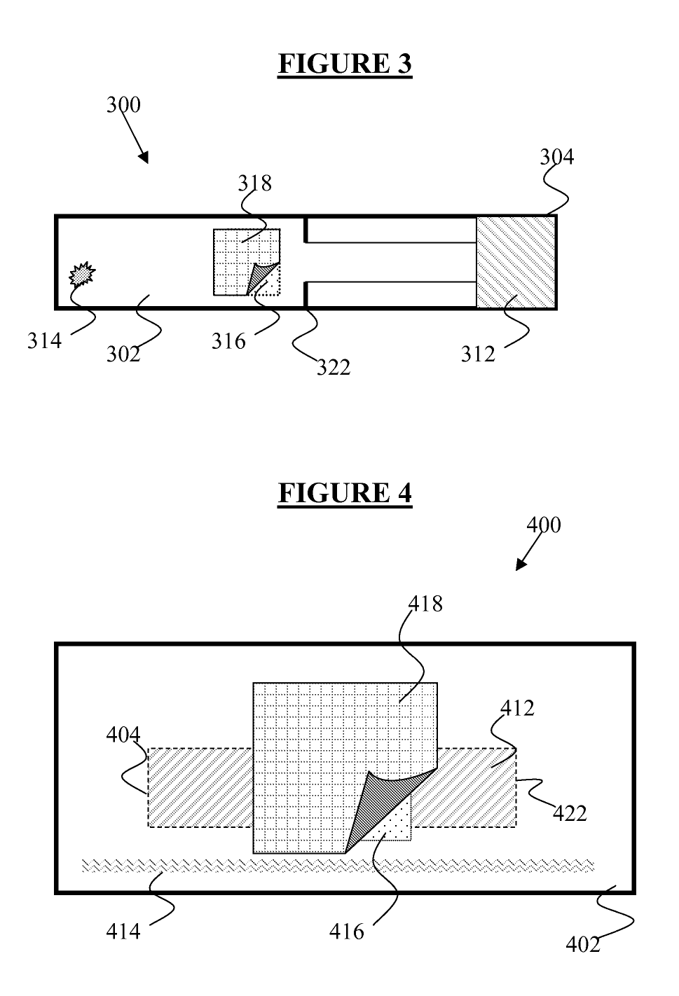

FIGS. 3 and 4 show top plan views sensory evaluation devices that allow the user to perform a dosing step.

Referring to FIG. 3, the sensory evaluation device comprises a first chamber 302 and a second chamber 304 wherein the first chamber contains an odor-emitting substance 314 and the second chamber contains an odor-absorbing material. The two chambers are separated by a breakable seal 322. In this embodiment, first chamber 302 contains a vapor-permeable barrier 316 that enables first chamber 302 to be in communication with the ambient environment. A barrier protector 318 is removably attached to vapor-permeable barrier 316 and protects vapor-permeable barrier 316 from communication with the ambient environment until such communication is desired. Vapor-permeable barrier 316 and barrier protector 318 are in an overlying configuration. The bottom peripheral edges of barrier protector 318 may contain an adhesive material (not shown), which removably couples vapor-permeable barrier 316 with the ambient environment. Other means to couple barrier protector 318 and vapor-permeable barrier 316 are possible, such as by way of example and not by way of limitation, static cling.

In operation, the user removes the barrier protector and smells the contents of the first chamber. The user then replaces the barrier protector and breaks the seal on the first chamber to empty the contents of the second chamber into the first chamber facilitating the dosing of the odor-emitting substance with the odor-absorbing material. Once dosed, the user removes the barrier protector and again smells the contents of the first chamber.

Referring to FIG. 3, the sensory evaluation device comprises a first chamber 302 and a second chamber 304 wherein the first chamber contains an odor-emitting substance 314 and the second chamber contains and odor-absorbing material 312. The two chambers are separated by a breakable seal 322. In this embodiment, first chamber 302 contains a vapor-permeable barrier 316 that enables first chamber 302 to be in communication with the ambient environment. A barrier protector 318 is removably attached to vapor-permeable barrier 316 and protects vapor-permeable barrier 316 from communication with the ambient environment until such communication is desired. In this embodiment, vapor-permeable barrier 316 and barrier protector 318 are in an overlying configuration. The bottom peripheral edges of barrier protector 318 may contain an adhesive material (not shown) which removably couples vapor-permeable barrier 316 with the ambient environment. Other means to couple barrier protector 318 and vapor-permeable barrier 316 are possible, such as by way of example and not by way of limitation, static cling.

In operation, the user removes barrier protector 318 and smells the contents of the first chamber (chamber 302). The user then replaces barrier protector 318 and breaks the seal 322 of chamber 302 to empty the contents of chamber 304 into the chamber 302 facilitating the dosing of odor-emitting substance 314 with odor-absorbing material 312. Effective dosing can be accomplished by agitating the sensory evaluation device to thoroughly mix the contents of chamber 302 with the contents of chamber 304. Once dosed, the user removes the barrier protector and again smells the contents of the first chamber.

Referring to FIG. 4, the sensory evaluation device comprises a first chamber 402 and a second chamber 404 wherein the first chamber contains an odor-emitting substance 414 and the second chamber contains and odor-absorbing material 412. The two chambers are separated by a breakable seal 422. In this embodiment first chamber 402 contains a vapor-permeable barrier 416 that enables first chamber 402 to be in communication with the ambient environment. A barrier protector 418 is removably attached to vapor-permeable barrier 416 and protects vapor-permeable barrier 416 from communication with the ambient environment until such communication is desired. In this embodiment, vapor-permeable barrier 416 and barrier protector 418 are in an overlying configuration. The bottom peripheral edges of barrier protector 418 may contain an adhesive material (not shown), which removably couples vapor-permeable barrier 416 with the ambient environment. Other means to couple barrier protector 418 and vapor-permeable barrier 416 are possible, such as by way of example and not by way of limitation, static cling.

In operation, the user removes barrier protector 418 and smells the contents of the first chamber (chamber 402). The user then replaces barrier protector 418 and breaks the seal 422 of chamber 402 to empty the contents of chamber 404 into the chamber 402, facilitating the dosing of odor-emitting substance 414 with odor-absorbing material 412. Effective dosing can be accomplished by agitating the sensory evaluation device to thoroughly mix the contents of chamber 402 with the contents of chamber 404. Once dosed, the user removes the barrier protector and again smells the contents of the first chamber.

By way of non-limiting examples, the sensory evaluation device could comprise a chamber, i.e., a jar, and a barrier protector, i.e., a lid, is removably connected to the jar by any suitable means known in the art, e.g., screwing, snapping, crimping. A perforated vapor-permeable barrier can optionally be positioned between the jar and the lid either permanently inlayed into the rim of the jar by any suitable means (e.g., injection molding) or temporarily affixed over the rim of the jar by any suitable means (e.g., crimping, gluing, etc.). In operation, the user removes barrier protector, i.e., lid, and smells the contents of the chamber, i.e., jar.

The present invention has been described herein in considerable detail to provide those skilled in the art with information relevant to apply the novel principles and to construct and use such specialized components as are required. Specifically, embodiments of the sensory evaluation device and method have been described with reference to the detection/lack of detection of odor-emitting substances. More specifically, the present invention has been described with reference to enabling a consumer to evaluate an odor-absorbing material such as an animal litter prior to purchase. However, it is to be understood that the present invention can be carried out by different equipment, materials and devices, and that various modifications, both as to the equipment and operating procedures, can be accomplished without departing from the scope of the invention itself. Further, the present invention is adaptable to any number of substances where sensory evaluation is a key component to the evaluation of a product's effectiveness.

The invention claimed is:

1. A sensory evaluation device for the evaluation of animal litter comprising:
at least one chamber closed off from the ambient environment and containing at least one odor-absorbing composition suitable for use as an animal litter;
at least one odor-emitting substance in direct communication with the at least one odor-absorbing composition;
at least one vapor-permeable barrier separating the at least one chamber and the ambient environment; and
at least one vapor-permeable barrier protector removably coupled to the at least one vapor-permeable barrier protecting the at least one vapor-permeable barrier and the at least one chamber from the ambient environment until removed.

2. The sensory evaluation device recited in claim 1 further comprising:
at least a second chamber closed off from the ambient environment and containing at least one additional odor-absorbing composition suitable for use as an animal litter, wherein the at least a second chamber is connected to the at least one chamber, but not in communication with the at least one chamber;
at least a second odor-emitting substance placed in direct communication with the at least one additional odor-absorbing composition;
at least a second vapor-permeable barrier in communication with the at least one additional chamber and the ambient environment; and
at least a second protector removably coupled to the at least a second vapor-permeable barrier protecting the at least a second vapor-permeable barrier and the at least one additional chamber from the ambient environment until removed.

3. The sensory evaluation device recited in claim 1 wherein the at least one odor-absorbing composition is a cat litter.

4. The sensory evaluation device recited in claim 1 wherein the animal litter is a clay-based, a silica gel-based, an organic material-based animal litter or mixtures thereof.

5. The sensory evaluation device recited in claim 1 wherein the at least one odor-emitting substance is selected from the group consisting of garlic oil, ammonia, onion powder, coffee, fish oil, sesame oil, vinegar, cat excrement and combinations thereof.

6. The sensory evaluation device recited in claim 1 wherein the at least one odor-emitting substance is dyed a color that allows visual confirmation that the at least one odor-emitting substance is in communication with the at least one odor-absorbing composition.

7. The sensory evaluation device recited in claim 1 wherein the at least one vapor-permeable barrier is selected from the group consisting of plastic, metal foil, paper, nonwoven material, glass and combinations thereof.

8. The sensory evaluation device recited in claim 1 wherein the at least one vapor-permeable barrier is perforated to the extent that it is permeable to vapors, but not solids greater than 500 μm.

9. The sensory evaluation device recited in claim 1 wherein the at least one protector is removably coupled to the at least one vapor-permeable barrier by means selected from the group consisting of adhesive, static cling, crimping, screwing, snapping and combinations thereof.

10. The sensory evaluation device recited in claim 1 wherein the at least one chamber and the at least one removable vapor-permeable barrier protector are configured as a jar and a lid.

11. The sensory evaluation device recited in claim 1 wherein the at least one vapor-permeable membrane and the at least one removable protector are configured as sheet-like layers.

12. A method of using a sensory evaluation device to evaluate the effectiveness of animal litter comprising:
storing a sensory evaluation device having at least one chamber closed off from the ambient environment and containing at least one odor-absorbing composition suitable for use as an animal litter; at least one odor-emitting substance in direct communication with the at least one odor-absorbing composition; and at least one chamber protector removably coupled to the at least one chamber protecting the at least one chamber from the ambient environment until removed;
removing the at least one chamber protector from the at least one chamber to bring the contents of the at least one chamber in communication with the ambient environment; and
allowing a person to sniff the contents of the at least one chamber.

13. The method recited in claim 12 further comprising the steps:
storing at least a second sensory evaluation device having at least a second chamber closed off from the ambient environment and containing at least one odor-absorbing composition suitable for use as an animal litter; at least one odor-emitting substance in direct communication with the at least one odor-absorbing composition; and at least a second chamber protector removably coupled to the at least a second chamber protecting the at least a second chamber from the ambient environment until removed;
removing the at least a second chamber protector to bring the contents of the at least a second chamber in communication with the ambient environment; and
allowing a user to sniff the contents of the at least a second chamber.

14. The method recited in claim 13 further comprising the step of:
comparing the odor emitted from the at least one sensory evaluation device to the odor emitted from the at least a second sensory evaluation device.

15. The method of using the sensory device recited in claim 12 wherein the device is presented to a consumer in a retail store.

16. The method of using the sensory evaluation device recited in claim 12 wherein the device is presented to a consumer via the mail.

17. The method of using the sensory evaluation device recited in claim 12 wherein the animal litter is a clay-based, a silica gel-based, an organic material-based cat litter and combinations thereof.

18. The method of using the sensory evaluation device recited in claim 12 wherein the at least one odor-emitting substance is selected from the group consisting of garlic oil, ammonia, onion powder, coffee, fish oil, sesame oil, vinegar, cat excrement and mixtures thereof.

19. The method of using the sensory evaluation device recited in claim 12 wherein the at least one odor-emitting substance is dyed a color that allows visual confirmation that the at least one odor-emitting substance is in communication with the at least one odor-absorbing composition.
